(19) United States
(12) Patent Application Publication
(10) Pub. No.: US 2013/0173559 A1
(43) Pub. Date: Jul. 4, 2013

(54) ELECTRONIC DEVICE, STORAGE MEDIUM, AND METHOD FOR RECOVERING DELETED FILES OF THE ELECTRONIC DEVICE

(71) Applicants: Shenzhen Futaihong Precision Industry Co., Ltd., Shenzhen (CN); Chi Mei Communication Systems, Inc., New Taipei (TW)

(72) Inventor: HONG-KUI CHEN, Shenzhen (CN)

(73) Assignees: CHI MEI COMMUNICATION SYSTEMS, INC., New Taipei (TW); SHENZHEN FUTAIHONG PRECISION INDUSTRY CO., LTD., Shenzhen (CN)

(21) Appl. No.: 13/711,702

(22) Filed: Dec. 12, 2012

(30) Foreign Application Priority Data
Dec. 30, 2011 (CN) 201110454593.5

(51) Int. Cl. G06F 17/30

(52) U.S. Cl. CPC G06F 17/3007
USPC 707/674

(57) ABSTRACT

In a method to recover deleted files of an electronic device, properties of a file are stored into a file list of a storage system of the electronic device when the file is deleted from the electronic device. The method compresses the deleted file, and stores the compressed file in a hidden partition of the storage system. The method further obtains the compressed file from the hidden partition when the deleted file needs to be recovered. Then, the method decompresses the compressed file, and stores the decompressed file to an active partition in the electronic device.

### BACKGROUND

1. Technical Field

The present disclosure relates to file recovery systems and methods, and more particularly to an electronic device, a storage medium, and a method for recovering deleted files of the electronic device.

2. Description of Related Art

When files of most electronic devices are deleted, the contents of the files are not erased, but, in most instances, the first character of each filename is changed to a special character and the deleted files are not listed in a file viewer. In some instances, the contents of the files are over-written with all ones or all zeroes, these files are considered as unrecoverable. In the case of the deleted files where the first character of the filename is changed, these files may be recoverable by resurrecting them from the recycle bin of the electronic device. However, because the recycle bin of an electronic device may be accessible by all users of the electronic device, recovering the deleted files by unauthorized users is likely. This is a security risk. Therefore, there is room for improvement in the art.

### BRIEF DESCRIPTION OF THE DRAWINGS

FIG. 1 is a block diagram of one embodiment of an electronic device including a file recovery system.

FIG. 2 is a flowchart of one embodiment of a method for recovering deleted files in the electronic device of FIG. 1.

FIG. 3 is a table illustrates properties of the files in a storage system of the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of non-transitory computer-readable medium include CDs, DVDs, BLU-RAY, flash memory, and hard disk drives.

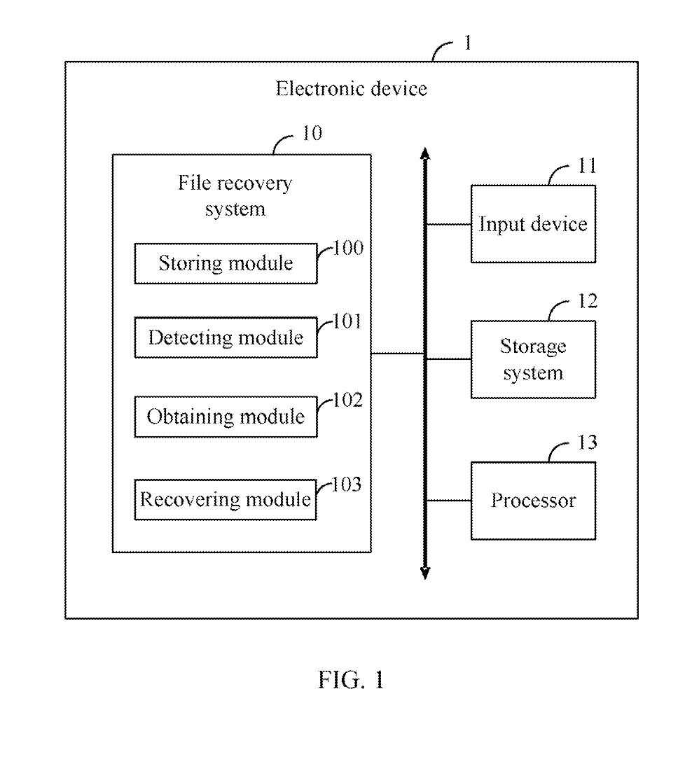

FIG. 1 is a block diagram of one embodiment of an electronic device 1 including a file recovery system 10. In the embodiment, the electronic device 1 may be a mobile phone, a notebook computer, a personal digital assistant (PDA), or any other communication device. The electronic device 1 further includes an input device 11, a storage system 12 and at least one processor 13.

In one embodiment, the file recovery system 10 detects whether a file is deleted from an active partition of the electronic device 1, reads the deleted file from a recycle bin of the electronic device 1 and stores the deleted file in a hidden partition of the storage system 12. The file recovery system 10 further recovers the deleted file from the hidden partition to the active partition when the deleted file needs to be recovered. The file may be a text document, an application, or/and a folder, for example. The hidden partition is a concealed storage area in the storage system 12.

The input device 11 receives an operation of a user when the deleted file needs to be recovered. In one embodiment, the operation may be a recovery operation that is used to recover the deleted file. The storage system 12 stores various files and data of the electronic device 1. In one embodiment, the storage system 12 may be an internal storage device, such as a read only memory (ROM) for permanent storage of information. In some embodiments, the storage system 12 may also be an external storage device, such as an external hard disk, a storage card, or a data storage medium. The at least one processor 13 executes one or more computerized codes and other applications of the electronic device 1 to provide the functions of the file recovery system 10.

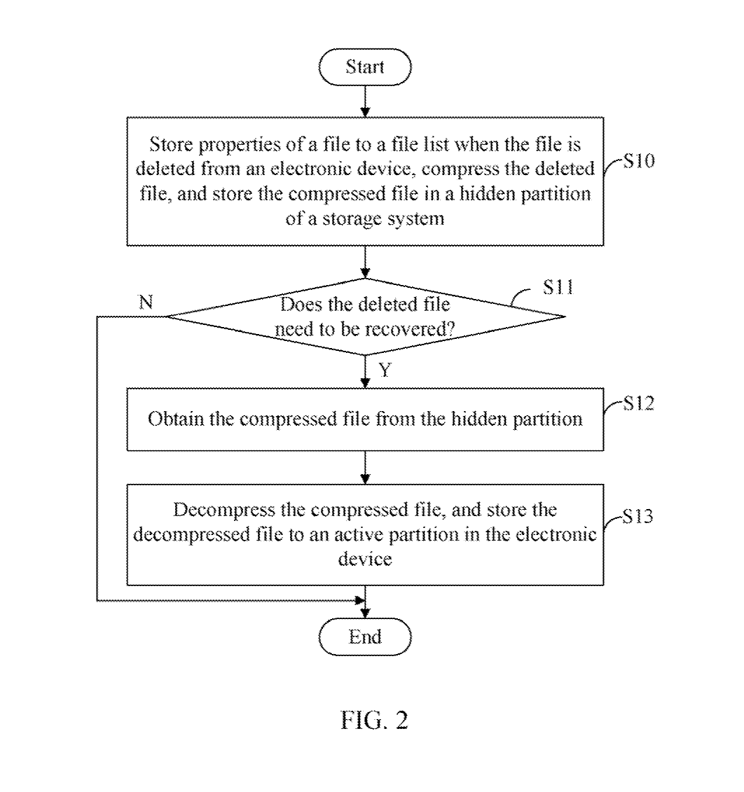

In one embodiment, the file recovery system 10 may include a storing module 100, a detecting module 101, an obtaining module 102, and a recovering module 103. The modules 100-103 comprise computerized codes in the form of one or more programs that are stored in the storage system 12 of the electronic device 1. The computerized code includes instructions that are executed by the at least one processor 13 of the electronic device 1 to provide functions for the modules. Details of each of the modules are given in FIG. 2.

FIG. 2 is a flowchart of one embodiment of a method for recovering deleted files in the electronic device of FIG. 1. Depending on the embodiment, additional steps may be added, others deleted, and the ordering of the steps may be changed.

In step S10, the storing module 100 stores properties of a file to a file list of the storage system 12 when the file is deleted from the electronic device 1. The storing module 100 further compresses the deleted file, and stores the compressed file in a hidden partition of the storage system 12. The hidden partition is a concealed storage area in the storage system 12.

In some embodiments, when a file is deleted, the contents of the deleted file is not erased, and the first character of the deleted file is changed to a special character and the deleted files are stored in a recycle bin of the electronic device 1. After the deleted file is read from the recycle bin, the storing module 100 gets rid of the deleted file from the recycle bin to avoid users to recover the deleted file from the recycle bin.

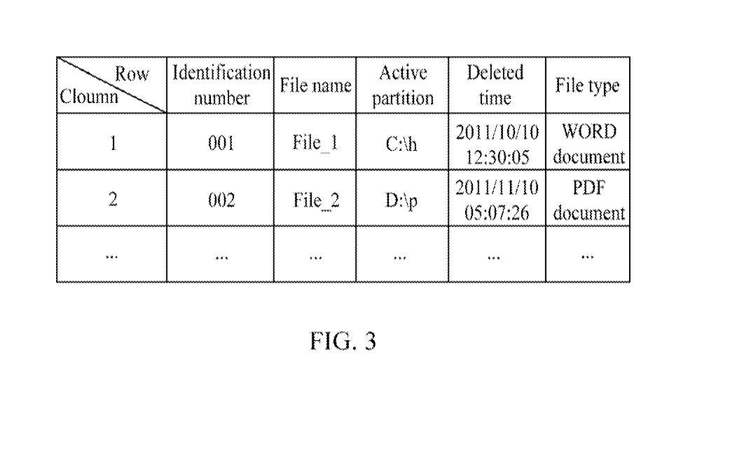

In one embodiment, the properties of the file may be an identification number, a file name, an active partition of the file, a deleted time for deleting the file, and a file type, for example. The properties are stored in the file list of the storage system 12, and each row of the file list records properties of a file deleted from the electronic device 1. Referring to FIG. 3, the row with the identification number 001 records the properties of a first deleted file (e.g., file_1), and the row with the identification number 002 records the properties of a second deleted file (e.g., file_2).

In one embodiment, the storing module 100 compresses the deleted file using a compression algorithm. The storing module 100 further adds the compressed file and the identification number of the compressed file to a compressed package. The compressed package is named according to the deleted time of the compressed file. When one file is deleted at a time, the compressed package has one compressed file. When more than one files are deleted at a time, the compressed package has more than one compressed files.

In one embodiment, the method to compress the deleted file is determined by using different compression algorithms. The method may package the deleted file overall for compressing, extract the deleted file to a binary byte stream for compressing, or encrypt the binary byte stream for compressing, for example.

In step S11, the detecting module 101 detects whether the deleted file needs to be recovered. If the deleted file needs to be recovered, step S12 is implemented. If the deleted file does not need to be recovered, the procedure ends.

In one embodiment, the detecting module 101 detects whether a recovery signal is obtained from the input device 11. The recovery signal is generated by an operation of a user on the input device 11. The operation may be a recovery operation (e.g. pressing a button of the input device 11) that is used to recover the deleted file. The recovery operation may recover the row with the identification number 001, for example. If the recovery signal is obtained from the input device 11, the detecting module 101 determines that the deleted file needs to be recovered. If the recovery signal is not obtained from the input device 11, the detecting module 101 determines that the deleted file does not need to be recovered.

In step S12, the obtaining module 102 obtains the compressed file corresponding to the deleted file from the hidden partition of the storage system 12. In one embodiment, the obtaining module 102 obtains the compressed package from the hidden partition according to the deleted time of the deleted file, and obtains the compressed file from the compressed package according to the identification number of the deleted file.

In step S13, the recovering module 103 decompresses the compressed file, and stores the decompressed file to the active partition of the deleted file in the electronic device 1. In one embodiment, the recovering module 103 decompresses the compressed file via using a decompression algorithm that corresponds to the compression algorithm, for example.

In one embodiment, the method to decompress the compressed file may package the compressed file overall for decompressing, integrate the compressed file with the binary byte stream for decompressing, or decrypt the integrated compressed file for decompressing, for example.

In the present disclosure, the file recovery system and method can store the deleted files in a hidden partition of the storage system 12 when the files are deleted from an active partition of the electronic device 1. The file recovery system and method further recover the deleted files to the active partition of the electronic device 1, so as to achieve or maintain a high security environment of the electronic device 1. It is convenient and efficient to recover the deleted files of the electronic device 1.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method of an electronic device for recovering deleted files of the electronic device, the method comprising:
(a) storing properties of a file to a file list of a storage system of the electronic device when the file being deleted from the electronic device, compressing the deleted file, and storing the compressed file in a hidden partition of the storage system;
(b) detecting whether the deleted file needs to be recovered;
(c) obtaining the compressed file from the hidden partition when the deleted file needs to be recovered; and
(d) decompressing the compressed file, and storing the decompressed file to an active partition in the electronic device.

2. The method as claimed in claim 1, wherein the properties of the file are stored in the file list of the storage system, and each row of the file list records properties of a file deleted from the electronic device.

3. The method as claimed in claim 1, wherein the properties of the file comprise an identification number, a file name, an active partition of the file, a deleted time for deleting the file, and a file type.

4. The method as claimed in claim 1, wherein step (a) further comprises:
compressing the deleted file; and
adding the compressed file and an identification number of the compressed file to a compressed package, wherein the compressed package is named according to a deleted time of the compressed file.

5. The method as claimed in claim 1, wherein step (b) further comprises:
determining that the deleted file needs to be recovered when a recovery signal is obtained from an input device of the electronic device, wherein the recovery signal is generated by an operation of a user on the input device; and
determining that the deleted file does not need to be recovered when the recovery signal is not obtained from the input device.

6. The method as claimed in claim 1, wherein step (c) further comprises:
obtaining the compressed package from the hidden partition according to a deleted time of the deleted file; and
obtaining the compressed file from the compressed package according to an identification number of the deleted file.

7. A non-transitory computer readable storage medium storing a set of instructions that, when executed by at least one processor of an electronic device, causes the at least one processor to perform a method for recovering deleted files of the electronic device, the method comprising:
(a) storing properties of a file to a file list of a storage system of the electronic device when the file being deleted from the electronic device, compressing the deleted file, and storing the compressed file in a hidden partition of the storage system;
(b) detecting whether the deleted file needs to be recovered;
(c) obtaining the compressed file from the hidden partition when the deleted file needs to be recovered; and
(d) decompressing the compressed file, and storing the decompressed file to an active partition in the electronic device.

8. The storage medium as claimed in claim 7, wherein the properties of the file are stored in the file list of the storage system, and each row of the file list records properties of a file deleted from the electronic device.

9. The storage medium as claimed in claim 7, wherein the properties of the file comprise an identification number, a file name, an active partition of the file, a deleted time for deleting the file, and a file type.

10. The storage medium as claimed in claim 7, wherein step (a) further comprises:
compressing the deleted file; and
adding the compressed file and an identification number of the compressed file to a compressed package, wherein the compressed package is named according to a deleted time of the compressed file.

11. The storage medium as claimed in claim 7, wherein step (b) further comprises:
determining that the deleted file needs to be recovered when a recovery signal is obtained from an input device of the electronic device, wherein the recovery signal is generated by an operation of a user on the input device; and
determining that the deleted file does not need to be recovered when the recovery signal is not obtained from the input device.

12. The storage medium as claimed in claim 7, wherein step (c) further comprises:
obtaining the compressed package from the hidden partition according to a deleted time of the deleted file; and
obtaining the compressed file from the compressed package according to an identification number of the deleted file.

13. An electronic device, comprising:
an input device;
a storage system;
at least one processor; and
one or more programs that are stored in the storage system and executed by the at least one processor, the one or more programs comprising:
a storing module that stores properties of a file to a file list of the storage system when the file is deleted from the electronic device, compresses the deleted file, and stores the compressed file in a hidden partition of the storage system;
a detecting module that detects whether the deleted file needs to be recovered;
an obtaining module that obtains the compressed file from the hidden partition when the deleted file needs to be recovered; and
a recovering module that decompresses the compressed file, and stores the decompressed file to an active partition in the electronic device.

14. The electronic device as claimed in claim 13, wherein the properties of the file are stored in the file list of the storage system, and each row of the file list records properties of a file deleted from the electronic device.

15. The electronic device as claimed in claim 13, wherein the properties of the file comprise an identification number, a file name, an active partition of the file, a deleted time for deleting the file, and a file type.

16. The electronic device as claimed in claim 13, wherein the storing module:
compresses the deleted file; and
adds the compressed file and an identification number of the compressed file to a compressed package, wherein the compressed package is named according to a deleted time of the compressed file.

17. The electronic device as claimed in claim 13, wherein the detecting module:
determines that the deleted file needs to be recovered when a recovery signal is obtained from the input device, wherein the recovery signal is generated by an operation of a user on the input device; and
determines that the deleted file does not need to be recovered when the recovery signal is not obtained from the input device.

18. The electronic device as claimed in claim 13, wherein the obtaining module:
obtains the compressed package from the hidden partition according to a deleted time of the deleted file; and
obtains the compressed file from the compressed package according to an identification number of the deleted file.
